(19) United States
(12) Patent Application Publication
(10) Pub. No.: US 2014/0173843 A1
(43) Pub. Date: Jun. 26, 2014

(54) PAINT APPLICATORS INCLUDING PAINT APPLICATION ELEMENT HAVING NON-STICK COATING

(71) Applicant: NOVA WILDCAT SHUR-LINE, LLC, Mooresville, NC (US)

(72) Inventors: David J. Merten, Manitowoc, WI (US); Jay Z. Muchin, Manitowoc, WI (US)

(73) Assignee: NOVA WILDCAT SHUR-LINE, LLC, Mooresville, NC (US)

(21) Appl. No.: 14/190,848

(22) Filed: Feb. 26, 2014

Related U.S. Application Data
(63) Continuation of application No. 12/288,813, filed on Oct. 23, 2008, now abandoned.
Application No. 12/288,813 is a division of application No. 11/281,259, filed on Nov. 17, 2005, now abandoned.
Application No. 11/281,259 is a continuation of application No. PCT/US03/36626, filed on Nov. 13, 2003.

(51) Int. Cl. A46D 1/00; B05C 17/02; B05C 17/00

(52) U.S. Cl. CPC A46D 1/02; B05C 17/00; B05C 17/0207
USPC 15/207.2; 15/209.1

(57) ABSTRACT

A paint applicator having a non-stick coating, such as a fluoropolymer polymer resin, applied thereto in order to improve the cleanability thereof.

### CROSS-REFERENCE TO RELATED APPLICATIONS

This application is a divisional application of and claims priority to co-pending U.S. application Ser. No. 11/281,259, filed on Nov. 17, 2005, entitled “PAINT APPLICATORS INCLUDING PAINT APPLICATION ELEMENT HAVING NON-STICK COATING” that claims priority under 35 U.S.C. §120 of Patent Cooperation Treaty International Application No. PCT/US2003/036626 filed on Nov. 13, 2003 entitled “PAINT APPLICATORS INCLUDING PAINT APPLICATION ELEMENT HAVING NON-STICK COATING”, the contents of which are herein incorporated by reference.

### FIELD OF THE DISCLOSURE

The present invention generally relates to paint applicators and more particularly to paint applicators including a paint application element which has a non-stick coating.

### BACKGROUND OF THE DISCLOSURE

The use of paint applicators such as paint brushes, paint rollers, and paint pads for the application of paint to walls and the like is well known. Brushes are useful in that they allow for accurate paint application and can be provided in a wide array of sizes. Paint rollers are often the tool of choice, especially for fast paint application to relatively large surfaces such as walls and ceilings. Foam pads absorb a relatively high volume of paint, and are suitable for applying paint to surfaces having intricate textures. Moreover, such pads often have a straight or angular edge enabling application of paint along a straight trim line or to a corner surface and the like.

In order to be successfully reused, however paint applicators such as paint brushes, paint rollers, and paint pads must be thoroughly cleaned. This is so because dried paint negatively affects the performance of the painting tool (e. g., the finish of the applied paint coating, the capacity of the painting tool to absorb and apply paint to a surface, etc.).

Cleaning a paint applicator is normally a messy and time-consuming operation. Typically, the paint applicator is thoroughly washed with water and/or organic solvents, depending on the type of paint. However, it is difficult to remove all of the paint from the paint applicator. Moreover, exposing paint applicators to organic solvents can deleteriously affect the performance of the paint applicator. For example, paint roller cover cores can comprise strips of a thermoplastic or paper material which are adhered to each other, and paint solvents such as turpentine, mineral spirits, etc. can dissolve many of the adhesive compounds which are used to adhere the strips to form the paint roller cover core.

Additionally, cleaning paint application elements such as paint roller covers normally requires users to remove the paint roller cover from the paint roller assembly by grasping the paint soaked paint roller cover and pulling it off of the frame of the paint roller assembly. Accordingly, the hands of the user contact paint and also must be thoroughly cleaned.

Various devices for cleaning painting applicators have been described.

For example, U.S. Pat. No. 4,641,673 discloses an open ended tubular housing for receiving a painting applicator that needs to be cleaned which includes at least one series of water jets. When used to clean paint rollers, the water jets are directed slightly off center of the paint roller in order to impart a spin to the roller which throws off the diluted paint and wash water. When used to clean paint brushes, water jets that are directed upwardly parallel to the bristles of the paint brush are activated.

U.S. Pat. No. 5,050,626 describes a similar device which utilizes water pressure generated spin to clean painting applicators. Paint brush combs have also been used to clean the paint brush filaments or bristles.

Although facilitating the thorough cleaning of paint applicators, such devices have drawbacks. For example, many of these devices are elaborate and require the utilization (and potential monopolization) of a water source. Moreover, a considerable amount of time and effort has to be expended to clean a paint applicator, even when using such devices. Finally, such devices do not provide an integrated solution for cleaning paint applicators, in that they merely address the result (i e., a paint soaked paint applicator).

### SUMMARY OF THE DISCLOSURE

Paint applicators including a paint application element which has a non-stick coating generally allow consumers to clean paint applicators quickly and thoroughly. Moreover, such paint applicators provide paint application elements capable of achieving increased paint loading and increased paint release, thereby allowing consumers to paint surfaces to be painted more quickly and efficiently.

According to one embodiment according to the disclosure, a paint applicator comprises a handle and a paint application element operatively connected to the handle, wherein at least a portion of the paint application element has a non-stick coating.

According to an additional embodiment according to the disclosure, a paint roller cover comprises a core and a pile fabric secured to the core, wherein at least a portion of the pile fabric has a non-stick coating.

According to another embodiment according to the disclosure, a paint brush comprises a handle, a ferrule secured to the handle, and a plurality of bristles having inner end portions received within the ferrule and outer end portions projecting from the ferrule, wherein at least a portion of the plurality of bristles has a non-stick coating.

### BRIEF DESCRIPTION OF THE DRAWINGS

Exemplary aspects and features of paint applicators including a paint application element which has a non-stick coating in accordance with the disclosure are described and explained in greater detail below with the aid of the drawing figures in which:

FIG. 1 is a perspective view illustrating a paint roller including a paint roller cover having a non-stick coating; and,

FIG. 2 is a perspective view illustrating a paint brush including bristles having a non-stick coating.

### DETAILED DESCRIPTION OF THE DISCLOSURE

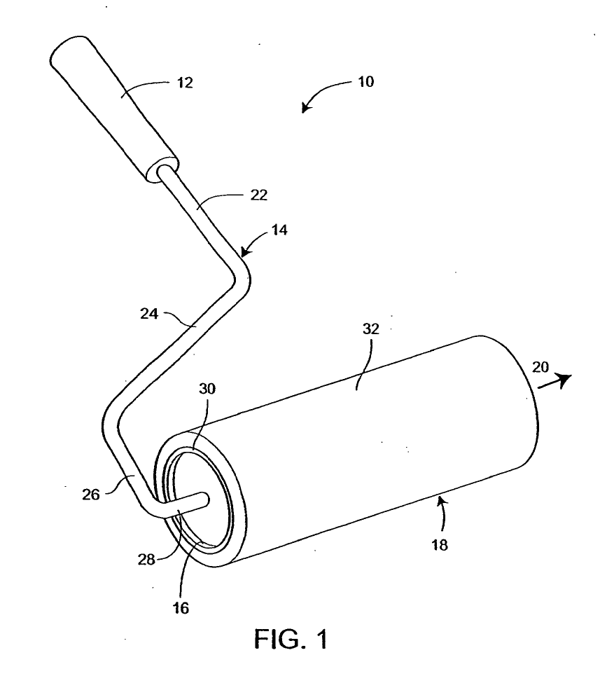

With reference to FIG. 1, a paint applicator including a paint application element which has a non-stick coating is shown as paint roller assembly 10. Paint roller assembly 10 generally includes a handle 12, a support arm 14, and a bearing member 16 for supporting a paint roller cover 18. The bearing member 16 rotatably supports the paint roller cover 18 about an axis 20. The handle 12 provides a surface about which a painter can grasp paint roller assembly 10. The support arm 14 generally comprises a rod, shaft, or other rigid structure 22 projecting from the handle 14, an angled arm 24 extending therefrom, an extension leg 26 extending from the angled arm 24, and an axle 28 for supporting the bearing member 16. The axle 28 is preferably configured such that roller 18 rotates about an axis substantially perpendicular to the handle 12. Although preferably formed from metal, the support ann 14 can alternatively be formed from plastic and can have other shapes or configurations. In an exemplary embodiment, the bearing member 16 comprises a conventionally known plastic cage rotatably supported about the axle 28 and adapted to frictionally engage an inside surface of the roller cover 18. Alternatively, the bearing member 16 can comprise a conventionally known wire cage.

The paint roller cover 18 generally comprises an elongate cylindrical core 30 having an outer circumferential surface configured to be rolled along a surface and to apply (or remove) paint from the adjacent surface. The tubular core 30 is sized so as to be fitted upon the rotatably mounted bearing member 16 of paint roller 10. The core 30 is typically formed from either a phenolic paper or a thermoplastic material. Cores 30 are preferably formed from thermoplastic material that is paint solvent resistant. Such thermoplastic cores 30 are typically either extruded or formed by bonding one or more strips of core material about a mandrel.

Cores 30 formed from strips are generally preferred due to the lower cost and continuous nature of the manufacturing process.

Paint roller covers 18 including thermoplastic cores 30 formed from strips of thermoplastic material are generally manufactured using one of two conventionally known methods. According to a first method, the core 30 is formed by extruding a thermoplastic tube or by wrapping plys or strips of thermoplastic material around a mandrel preferably with an upper strip overlapping a lower strip. The opposing faces of the strips are heated so that upon contacting engagement of the strips, the heated surfaces contact one another and bond with one another. Once the core 30 is formed, the outer surface of the core 30 is subjected to a second application of heat to soften and melt the outer surface of the core. While in this adhesive state, a pile fabric 32 is secured to the core 30. For example, a strip of fabric pile 32 is wrapped about the core 30 to thereby form the roller cover 18 which is then cut, if needed, to desired lengths. Examples of such processes are set forth in U.S. Pat. Nos. 5,206,968; and 5,468,207.

The pile fabric 32 holds and retains paint or other liquid coating until the paint or liquid coating is applied to a surface such as a wall. The cylindrical core 30 can be covered by various materials including fabric nap, mohair, natural or synthetic sponge, felt, and the like for the adsorption and application of paint, as is conventionally known.

The pile fabric 32 is treated with a non-stick solution selected from solutions comprising a fluoropolymer resin or an inorganic dry lubricant, in order to provide a non-stick coating on the surface of the pile fabric. Examples of suitable non-stick solutions include but are not limited to solutions comprising polytetrafluoroethylene (PTFE), fluorinated ethylenepropylene (FEP), polyvinylidene fluoride (PVDF), perfluoroalkoxy (PFA), ethylene chlorotrifluoroethylene (ECTFE), molybdenum disulfide (MoS2), and blends thereof The non-stick solutions can further comprise conventionally known film-formers to produce composite non-stick coatings of superior performance. Paint roller assemblies 10 including paint roller covers 18 which have such a non-stick coating allow consumers to clean the paint roller cover 18 quickly and thoroughly. Moreover, such paint applicators provide paint roller covers 18 capable of increased paint loading and increased paint release, thereby allowing consumers to paint surfaces more quickly and efficiently.

According to one embodiment of the disclosure, other portions of the applicator 10 may be similarly coated with a non-stick solution to facilitate their cleaning as well. Such portions include but are not limited to the handle 12, arm 14, and bearing member 16.

Various methods can be used to apply the non-stick coating to the pile fabric 32. For example, the non-stick coating may be applied by soaking or dipping the pile fabric 32 in a solution of the coating material; by spraying or misting a solution comprising the coating material onto the pile fabric 32; by a kiss coat process wherein the coating is applied to the pile fabric by a roller or another form of mechanical transfer; and by foaming wherein the coating is foamed with one or more foaming agents (as is conventionally known), and is applied to the pile fabric fibers.

Of course, these application methods are exemplary only, and other suitable coating methods can be used to provide the non-stick coating.

For example, according to one alternative embodiment of the disclosure, the pile fabric fibers can be formed by an extrusion process wherein the pile fabric fibers are extruded and manufactured from the coating material resin to provide a paint roller cover exhibiting superior performance. In another embodiment, a suitable non-stick resin and a fiber resin can be melted and mixed together prior to extruding the fibers.

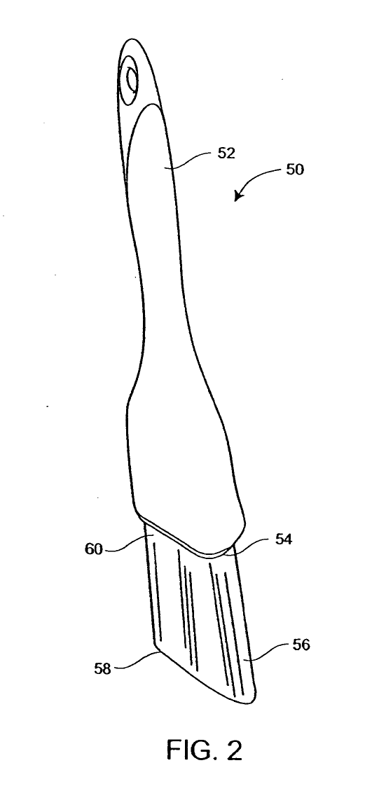

Referring now to FIG. 2, a paint applicator including a paint application element which has a non-stick coating is shown as paint brush 50. Brush 50 has a handle 52 and a ferrule 54 secured to the handle 52. Ferrule 54 may be a metal band and extend around the upper end portion of the handle 20 to secure bristles 56 thereto. Ferrule 54 may be secured thereto by a securing means (not shown) such as an adhesive or nails, screws, staples, etc. Alternatively, ferrule 54 may be another material such as plastic and be secured inwardly of the handle 52.

The brush 50 also includes a plurality of bristles 56 having inner end portions received within the ferrule 54 and outer end portions 58 projecting from the ferrule 54. Typically, a bristle setting material such as an epoxy resin material is used to retain the bristles within the ferrule 54.

Handle 52 may be manufactured from a variety of materials, including wood and plastics. Ferrule 54 may similarly be manufactured from a variety of materials, including metals and plastics. A plurality of bristles 56 are received within the ferrule 54. The bristles have inner or“butt”end portions (not shown) which are retained inside the ferrule 54, and outer end portions 5 which project from the ferrule 54. The bristles 56 themselves may be of any type conventionally used in the paint brush art and may be natural or synthetic.

The plurality of bristles are typically treated with a non-stick solution selected from solutions comprising a fluoropolymer resin or an inorganic dry lubricant, in order to provide a non-stick coating on the surface of the bristles or filaments. Examples of suitable non-stick solutions include but are not limited to solutions comprising polytetrafluoroethylene (PTFE), fluorinated ethylenepropylene (FEP), polyvinylidene fluoride (PVDF), perfluoroalkoxy (PFA), ethylene chlorotrifluoroethylene (ECTFE), molybdenum disulfide (MoS2), and blends thereof.

The non-stick solutions can further comprise conventionally known film-formers to produce composite non-stick coatings of superior performance.

Paint brushes 50 including bristles 56 which have such a non-stick coating allow consumers to clean the brush quickly and thoroughly. Moreover, brushes 50 which have a non-stick coating in accordance with the disclosure allow the consumer to easily clean the heel 60 of the brush, i. e., the portion of the brush 50 proximate to the ferrule 54, which is notoriously difficult to clean. Moreover, such paint applicators provide paint brushes capable of increased paint loading and increased paint release, thereby allowing consumers to paint surfaces to be painted more quickly and efficiently.

According to one embodiment of the invention, the ferrule 54 is also coated with a non-stick solution such as those given above. Coating the ferrule 54 in such a fashion allows consumers to easily and efficiently clean the ferrule 54. In still further embodiments, the handle 52 may be similarly coated with a non-stick solution.

Of course, the non-stick coating solutions can also be applied to other paint applicators such as paint pads.

Various methods can be used to apply the non-stick coating to the bristles 54. For example, the non-stick coating may be applied by soaking the bristles 54 in a solution of the coating material; by spraying or misting a solution comprising the coating material onto the bristles 54; by a kiss coat process wherein the coating is applied to the bristles 54 by a roller or another form of mechanical transfer; and by foaming wherein the coating is foamed with one or more foaming agents (as is conventionally known), and is applied to bristles 54. Of course, these application methods are exemplary only, and other suitable coating methods can be used to coat the bristles 54 with the non-stick coating.

For example, according to one alternative embodiment of the disclosure, the bristles 54 can be formed by an extrusion process wherein the pile fabric fibers are extruded and manufactured from the coating material resin to provide a paint roller cover exhibiting superior performance. In another embodiment, a suitable non-stick resin and a fiber resin can be melted and mixed together prior to extruding the bristles.

Although the foregoing text sets forth a detailed description of numerous different embodiments of a container for a paint roller assembly, it should be understood that the detailed description is to be construed as exemplary only and does not describe every possible embodiment of a paint applicator with a non-stick coating according to the present disclosure.

What is claimed is:

1. A paint applicator comprising,
a handle,
a paint application element operatively connected to the handle, and
a non-stick coating provided on at least a portion of the paint application element.

2. The paint applicator according to claim 1 wherein the paint application element is a plurality of paint brush bristles.

3. The paint applicator according to claim 1 wherein the paint application element is a paint pad.

4. The paint applicator according to claim 1 wherein the non-stick coating comprises a fluoropolymer resin.

5. The paint applicator according to claim 1 wherein the non-stick coating comprises an inorganic dry lubricant.

6. The paint applicator according to claim 1 wherein the non-stick coating comprises a substance selected from the group consisting of polytetrafluoroethylene (PTFE), fluorinated ethylenepropylene (FEP), polyvinylidene fluoride (PVDF), perfluoroalkoxy (PFA), ethylene chlorotrifluoroethylene (ECTFE), and molybdenum disulfide (MoS2).

7. The paint applicator according to claim 1 wherein a non-stick coating is also provided on the handle.

8. A paint brush comprising,
a handle,
a ferrule secured to the handle,
a plurality of bristles having inner end portions received within the ferrule and outer end portions projecting from the ferrule, and
a non-stick coating provided on at least a portion of the plurality of bristles.

9. The paint brush according to claim 8 wherein the non-stick coating comprises a fluoropolymer resin.

10. The paint brush according to claim 8 wherein the non-stick coating comprises an inorganic dry lubricant.

11. The paint brush according to claim 8 wherein the non-stick coating comprises a substance selected from the group consisting of polytetrafluoroethylene (PTFE), fluorinated ethylenepropylene (FEP), polyvinylidene fluoride (PVDF), perfluoroalkoxy (PFA), ethylene chlorotrifluoroethylene (ECTFE), and molybdenum disulfide (MoS2).

12. The paint brush according to claim 8 wherein a non-stick coating is also provided on the ferrule.

13. The paint brush according to claim 8 wherein a non-stick coating is also provided on the handle.
